(19) United States
(12) Patent Application Publication
(10) Pub. No.: US 2020/0112035 A1
(43) Pub. Date: Apr. 9, 2020

(54) FUEL CELL

(71) Applicant: HONDA MOTOR CO., LTD., Tokyo (JP)

(72) Inventor: Naoki Yamano, Wako-shi (JP)

(21) Appl. No.: 16/585,046

(22) Filed: Sep. 27, 2019

(30) Foreign Application Priority Data
Oct. 3, 2018 (JP) 2018-188302

(51) Int. Cl. H01M 8/0258; H01M 8/1004; H01M 8/0206

(52) U.S. Cl. CPC H01M 8/0258; H01M 8/0206; H01M 8/1004

(57) ABSTRACT

In a fuel cell, a first porous body is provided between a first metal separator and a membrane electrode assembly. First flow grooves as a passage of a reactant gas are formed in the first porous body. The first flow grooves extend in a wavy pattern. Second flow grooves as a passage of a reactant gas are formed in the first metal separator. The second flow grooves extend in a straight pattern. The first flow grooves extend through the first porous body in a thickness direction of the first porous body, and the first flow grooves are connected to the second flow grooves.

### CROSS-REFERENCE TO RELATED APPLICATION

This application is based upon and claims the benefit of priority from Japanese Patent Application No. 2018-188302 filed on Oct. 3, 2018, the contents of which are incorporated herein by reference.

### BACKGROUND OF THE INVENTION

### Field of the Invention

The present invention relates a fuel cell including a membrane electrode assembly and metal separators provided on both sides of the membrane electrode assembly.

### Description of the Related Art

For example, Japanese Patent No. 4948823 discloses a fuel cell including a membrane electrode assembly (MEA) and metal separators sandwiching the membrane electrode assembly. The membrane electrode assembly includes an electrolyte membrane, and an anode and a cathode provided on both sides of the electrolyte membrane. In the fuel cell, reactant gas flow fields for supplying reactant gasses along electrode surfaces of the membrane electrode assembly are formed only in the metal separators.

### SUMMARY OF THE INVENTION

The reactant gas flow fields as disclosed in Japanese Patent No. 4948823 described above is formed by press forming of the metal separators. In the fuel cell, in the case of forming the reactant gas flow fields only in the metal separators, the depth of the reactant gas flow field in a direction in which the membrane electrode assembly and the metal separator stacked together becomes comparatively large. Further, in the case where the reactant gas flow field is formed in a wavy pattern in a plan view, the size of the radius of curvature (R) and the flow field pitch become small. Therefore, the shape of the molding die is complicated. For this reason, the cost of the molding die is high, and the product life is short. Accordingly, the production cost of the fuel cell is high.

Further, in the fuel cell, it is desired to improve power generation efficiency by guiding the reactant gases to the membrane electrode assembly smoothly.

The present invention has been made taking such problems into account, and an object of the present invention is to provide a fuel cell which makes it possible to achieve reduction of the production cost, and improve power generation efficiency.

According to an aspect of the present invention, a fuel cell is provided, and the fuel cell includes a membrane electrode assembly and metal separators provided on both sides of the membrane electrode assembly, wherein a porous body is provided between each of the metal separators and the membrane electrode assembly, a first reactant gas flow field as a passage of a reactant gas is formed in the porous body, the first reactant gas flow field extending in a wavy pattern along an electrode surface of the membrane electrode assembly, a second reactant gas flow field as a passage of a reactant gas is formed in the metal separator, the second reactant gas flow field extending in a straight pattern along the electrode surface, and the first reactant gas flow field extends through the porous body in a thickness direction of the porous body, and the first reactant gas flow field is connected to the second reactant gas flow field.

According to another aspect of the present invention, a fuel cell is provided, and the fuel cell includes a membrane electrode assembly and metal separators provided on both sides of the membrane electrode assembly, wherein a porous body is provided between each of the metal separators and the membrane electrode assembly, a first reactant gas flow field as a passage of a reactant gas is formed in the porous body, the first reactant gas flow field extending in a straight pattern along an electrode surface of the membrane electrode assembly, a second reactant gas flow field as a passage of a reactant gas is formed in the metal separator, the second reactant gas flow field extending in a wavy pattern along the electrode surface, and the first reactant gas flow field extends through the porous body in a thickness direction of the porous body, and the first reactant gas flow field is connected to the second reactant gas flow field.

In the structure, since the first reactant gas flow field is formed in the porous body, and the second reactant gas flow field is formed in the metal separator, it becomes possible to comparatively reduce the depth of the second reactant gas flow field. Therefore, since it is possible to simplify the shape of the molding die for forming the second reactant gas flow field, it is possible to achieve reduction of the production cost of the molding die and extension of the product life of the molding die. Accordingly, it is possible to achieve reduction of the production cost of the fuel cell. Further, since the first reactant gas flow field is formed in the porous body, in comparison with the case where the reactant gas flow field is formed only in the metal separator, it is possible to reduce the pressure losses of the reactant gases, and improve gas diffusion performance for the membrane electrode assembly. Accordingly, it is possible to improve the power generation efficiency.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exploded perspective view with partial omission, showing a fuel cell stack including a fuel cell according to an embodiment of the present invention;

FIG. 2 is a cross sectional view taken along a line II-II in FIG. 1;

FIG. 3 is a plan view as viewed from a side where a first porous body is present, showing a resin film equipped MEA in FIG. 1;

FIG. 4 is a view showing a second oxygen-containing gas flow field in FIG. 2;

FIG. 5 is a plan view as viewed from a side where a first metal separator in FIG. 1 is present, showing the resin film equipped MEA;

FIG. 6 is a plan view as viewed from a side where a second porous body is present, showing the resin film equipped MEA in FIG. 1;

FIG. 7 is a view showing a second fuel gas flow field in FIG. 2;

FIG. 8 is a plan view as viewed from a side where a second metal separator in FIG. 1 is present, showing the resin film equipped MEA;

FIG. 9 is a vertical cross sectional view with partial omission showing a fuel cell stack including a fuel cell according to a modified embodiment;

FIG. 10 is a view showing a first oxygen-containing gas flow field and a second oxygen-containing gas flow field in FIG. 9; and

FIG. 11 is a view showing a first fuel gas flow field and a second fuel gas flow field in FIG. 9.

### DESCRIPTION OF THE PREFERRED EMBODIMENTS

Hereinafter, a preferred embodiment of a fuel cell according to the present invention will be described with reference to the accompanying drawings.

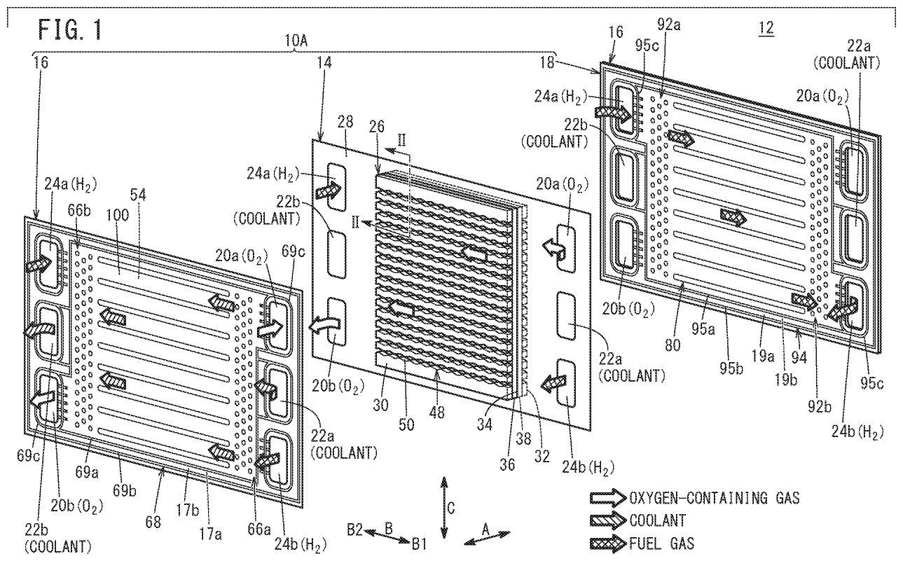

A fuel cell 10A shown in FIG. 1 forms a fuel cell stack 12. For example, a plurality of the fuel cells 10A are stacked together in a direction (horizontal direction) indicated by an arrow A or in a direction (gravity direction) indicated by an arrow C, and a tightening load (compression load) is applied to the fuel cells 10A in the stacking direction to form the fuel cell stack 12. For example, the fuel cell stack 12 is mounted in a fuel cell electric automobile (not shown).

The fuel cell 10A is a power generation cell which performs power generation by electrochemical reactions of a fuel gas and an oxygen-containing gas. The fuel cell 10A includes a resin film equipped MEA 14, a first metal separator 16 provided on one surface of the resin film equipped MEA 14, and a second metal separator 18 provided on the other surface of the resin film equipped MEA 14.

At one end of the fuel cell 10A in a longitudinal direction (horizontal direction) (an end in a direction indicated by an arrow B1), an oxygen-containing gas supply passage 20a, a coolant supply passage 22a, and a fuel gas discharge passage 24b are provided. The oxygen-containing gas supply passage 20a, the coolant supply passage 22a, and the fuel gas discharge passage 24b are arranged in a vertical direction (indicated by the arrow C).

The oxygen-containing gas supply passage 20a extends through each of the fuel cells 10A in the stacking direction (indicated by the arrow A) for supplying an oxygen-containing gas to each of the fuel cells 10A. The coolant supply passage 22a extends through each of the fuel cells 10A in the stacking direction, for supplying a coolant such as water to each of the fuel cells 10A. The fuel gas discharge passage 24b extends through each of the fuel cells 10A in the stacking direction, for discharging a fuel gas such as a hydrogen-containing gas from each of the fuel cells 10A.

At the other end of the fuel cell 10A in the longitudinal direction (horizontal direction) (an end indicated by an arrow B2), a fuel gas supply passage 24a, a coolant discharge passage 22b, and an oxygen-containing gas discharge passage 20b are provided. The fuel gas supply passage 24a, the coolant discharge passage 22b, and the oxygen-containing gas discharge passage 20b are arranged in the vertical direction (indicated by the arrow C).

The fuel gas supply passage 24a extends through each of the fuel cells 10A in the stacking direction, for supplying the fuel gas. The coolant discharge passage 22b extends through each of the fuel cells 10A in the stacking direction, for discharging the coolant. The oxygen-containing gas discharge passage 20b extends through each of the fuel cells 10A, for discharging the oxygen-containing gas.

The layout of the oxygen-containing gas supply passage 20a, the oxygen-containing gas discharge passage 20b, the fuel gas supply passage 24a, and the fuel gas discharge passage 24b is not limited to the illustrated embodiment, and may be designed as necessary depending on the required specification.

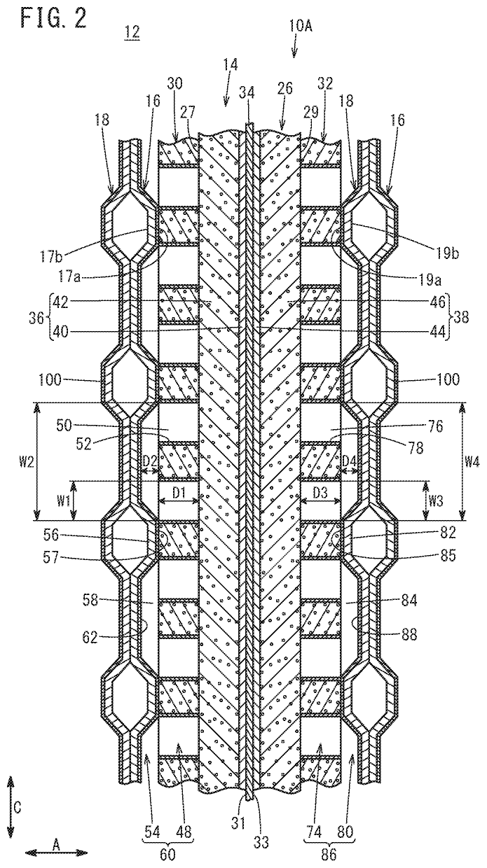

As shown in FIGS. 1 and 2, the resin film equipped MEA 14 includes a membrane electrode assembly 26 (MEA), a frame shaped resin film 28 (FIG. 1) provided on an outer peripheral portion of the membrane electrode assembly 26, a first porous body 30 provided on one surface 27 of the membrane electrode assembly 26, and a second porous body 32 provided on another surface 29 of the membrane electrode assembly 26.

The membrane electrode assembly 26 includes an electrolyte membrane 34, and a cathode 36 and an anode 38 provided on both sides of the electrolyte membrane 34. For example, the electrolyte membrane 34 includes a solid polymer electrolyte membrane (cation ion exchange membrane). For example, the solid polymer electrolyte membrane is a thin membrane of perfluorosulfonic acid containing water. The electrolyte membrane 34 is interposed between the anode 38 and the cathode 36. A fluorine based electrolyte may be used as the electrolyte membrane 34. Alternatively, an HC (hydrocarbon) based electrolyte may be used as the electrolyte membrane 34.

As shown in FIG. 2, the cathode 36 includes a first electrode catalyst layer 40 joined to one surface 31 of the electrolyte membrane 34, and a first gas diffusion layer 42 stacked on the first electrode catalyst layer 40. The first gas diffusion layer 42 is made of electrically conductive material capable of diffusing gases easily. Examples of such material include carbon paper or carbon cloth.

The anode 38 includes a second electrode catalyst layer 44 joined to another surface 33 of the electrolyte membrane 34, and a second gas diffusion layer 46 stacked on the second electrode catalyst layer 44. The second gas diffusion layer 46 is made of electrically conductive material capable of diffusing gases easily. Examples of such material includes carbon paper or carbon cloth.

In FIG. 1, the resin film 28 has a frame shape. An inner peripheral end surface of the resin film 28 is positioned close to, overlapped with, or contact an outer peripheral end surface of the electrolyte membrane 34. At an end of the resin film 28 in a direction indicated by an arrow B1, the oxygen-containing gas supply passage 20a, the coolant supply passage 22a, and the fuel gas discharge passage 24b are provided. At an end of the resin film 28 in a direction indicated by an arrow B2, the fuel gas supply passage 24a, the coolant discharge passage 22b, and the oxygen-containing gas discharge passage 20b are provided.

For example, the resin film 28 is made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

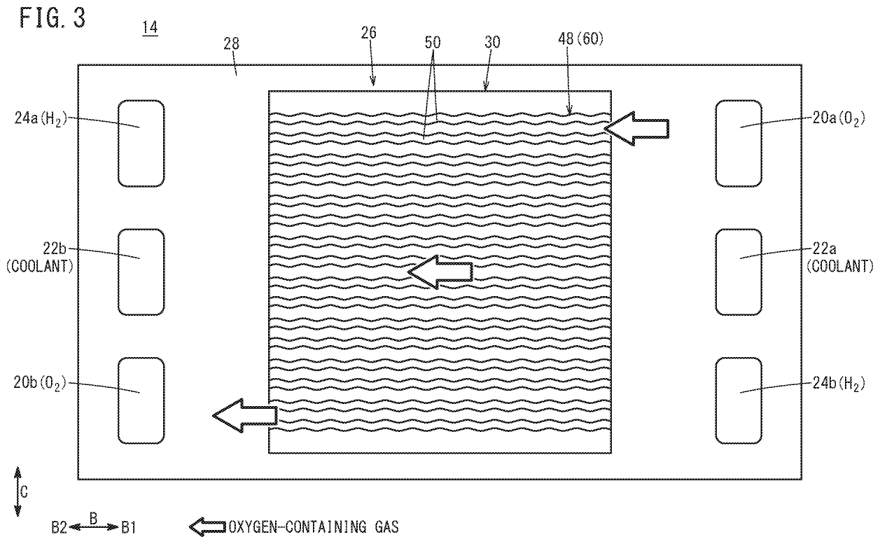

In FIGS. 2 and 3, the first porous body 30 is a rectangular flat member having electrical conductivity provided between the first metal separator 16 and the membrane electrode assembly 26. The first porous body 30 is joined to one surface (first gas diffusion layer 42) of the membrane electrode assembly 26. The first porous body 30 is made of the same material as the first gas diffusion layer 42. That is, for example, the first porous body 30 is made of carbon paper, etc. The first porous body 30 may be made of metal mesh.

As shown in FIG. 3, the first porous body 30 has substantially the same size as the size of the membrane electrode assembly 26 in a plan view viewed in the stacking direction. However, the first porous body 30 may have any size and shape.

A first oxygen-containing gas flow field 48 for supplying an oxygen-containing gas to the first gas diffusion layer 42 is formed in the first porous body 30. The first oxygen-containing gas flow field 48 includes a plurality of first flow grooves 50 (first reactant gas flow field) which form a passage of the oxygen-containing gas as a reactant gas. The first flow grooves 50 extend in a wavy pattern along the cathode 36 (FIG. 2) forming an electrode surface in a direction indicated by the arrow B. The first flow grooves 50 (first oxygen-containing gas flow field 48) extend in a wavy pattern over the entire length of the first porous body 30 in the direction indicated by the arrow B. The plurality of first flow grooves 50 are arranged at equal intervals in the direction indicated by the arrow C (width direction of the first flow grooves 50).

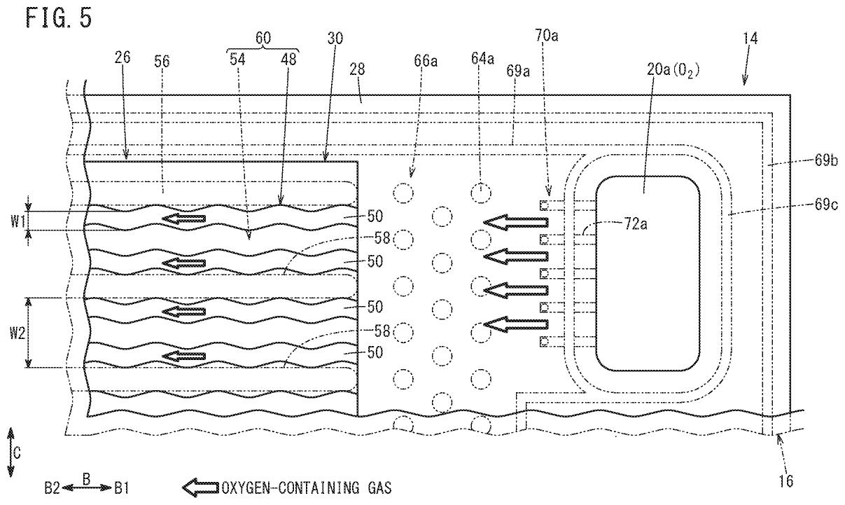

A width W1 (FIG. 5) and a depth D1 (FIG. 2) of the first flow grooves 50 are substantially constant over the entire length of the first flow grooves 50. It should be noted that the width W1 (FIG. 5) and the depth D1 (FIG. 2) of the first flow grooves 50 may change depending on the position in a direction in which the first flow grooves 50 extend.

In FIG. 2, the first flow grooves 50 extend through the first porous body 30, in a thickness direction (stacking direction) of the first porous body 30. The first flow grooves 50 have a rectangular shape in lateral cross section. It should be noted that the first flow grooves 50 need not necessarily have a rectangular shape in lateral cross section.

A water repellent part 52 is provided for a wall surface forming the first flow grooves 50. For example, the water repellent part 52 is formed by coating the wall surface that forms the first flow grooves 50, with alcohol solution containing fluorine resin. It should be noted that any method may be used to form the water repellent part 52 in or on the wall surface forming the first flow grooves 50. For example, the first porous body 30 may be formed to contain material having water repellency to form the water repellent part 52 in the wall surface forming the first flow grooves 50.

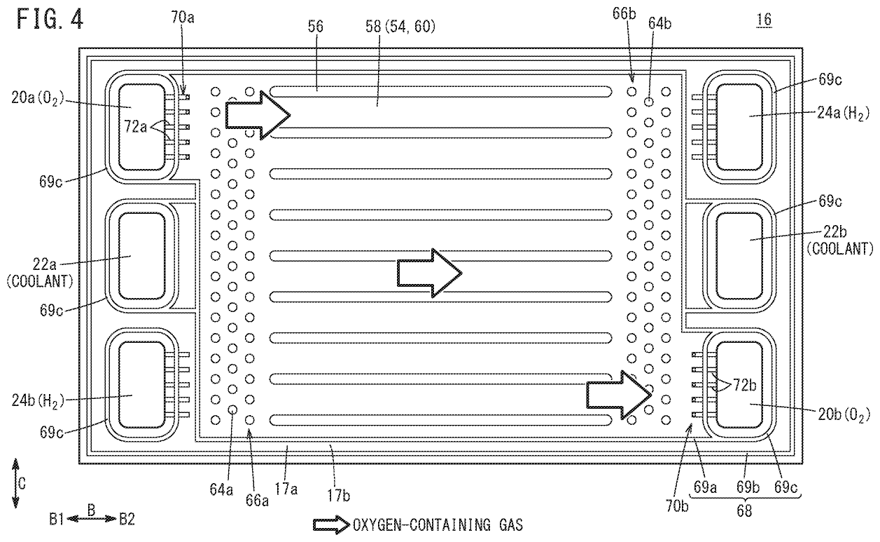

As shown in FIG. 4, the first metal separator 16 has a second oxygen-containing gas flow field 54 on its surface (hereinafter referred to as a “surface 17a”) facing the resin film equipped MEA 14. For example, the second oxygen-containing gas flow field 54 extends in the direction indicated by the arrow B. The second oxygen-containing gas flow field 54 includes a plurality of second flow grooves 58 (second reactant gas flow field) provided between a plurality of ridges 56 extending in a straight pattern in the direction indicated by the arrow B. Stated otherwise, the second oxygen-containing gas flow field 54 is formed by press forming of a metal flat plate. That is, the second flow grooves 58 extend in a straight pattern in the direction indicated by the arrow B.

As shown in FIG. 2, protruding end surfaces 57 of the ridges 56 contact the first porous body 30. A width W2 (FIG. 5) and a depth D2 of the second flow grooves 58 are substantially constant over the entire length of the second flow grooves 58. It should be noted that the width W2 (FIG. 5) and the depth D2 of the second flow grooves 58 may change depending on the position in a direction in which the second flow grooves 58 extend. The second flow grooves 58 are connected to the plurality of (in the embodiment of the present invention, e.g., two) first flow grooves 50.

Stated otherwise, in FIG. 5, the second flow grooves 58 are overlapped with a plurality of (two, in the embodiment of the present invention) first flow grooves 50, in a plan view viewed in the stacking direction. The width W2 of the second flow grooves 58 is larger than the width W1 of the first flow grooves 50. Specifically, the width W2 of the second flow grooves 58 is two or more times larger than the width W1 of the first flow grooves 50. In FIG. 2, the depth D2 of the second flow grooves 58 is smaller than the depth D1 of the first flow grooves 50. Specifically, the depth D2 of the second flow grooves 58 is not more than ½ of the depth D1 of the first flow grooves 50. The widths W1, W2, the pitch, and the amplitude of the first flow grooves 50 and the second flow grooves 58 should be determined as necessary in a manner that the first flow grooves 50 and the second flow grooves 58 are overlapped with each other in a plan view.

The first oxygen-containing gas flow field 48 and the second oxygen-containing gas flow field 54 are connected together to form an oxygen-containing gas flow field 60 for supplying the oxygen-containing gas to the cathode 36. The oxygen-containing gas flow field 60 is connected to (in fluid communication with) the oxygen-containing gas supply passage 20a and the oxygen-containing gas discharge passage 20b (see FIGS. 3 and 4).

An electrically conductive hydrophilic part 62 is provided for a wall surface forming the second flow grooves 58. For example, the hydrophilic part 62 is formed by depositing TiO₂ (titanium oxide) by thermal oxidation. However, any method may be used to form the hydrophilic part 62 in or on the wall surface forming the second flow grooves 58. The hydrophilic part 62 need not necessarily be provided on a contact surface with the first porous body 30.

As shown in FIG. 4, on the surface 17a of the first metal separator 16, an inlet buffer 66a including a plurality of bosses 64a is provided between the oxygen-containing gas supply passage 20a and the second oxygen-containing gas flow field 54. On the surface 17a of the first metal separator 16, an outlet buffer 66b including a plurality of bosses 64b is provided between the oxygen-containing gas discharge passage 20b and the second oxygen-containing gas flow field 54.

A first seal line 68 is formed by press forming on the surface 17a of the first metal separator 16. The first seal line 68 protrudes toward the resin film equipped MEA 14 (FIG. 1). Resin material may be fixed to a ridge shaped front end surface of the first seal line 68 by printing or coating. For example, polyester fiber may be used as the resin material. The resin material may be provided on the part of the resin film 28.

The first seal line 68 includes a bead seal (hereinafter referred to as an “inner bead 69a”) provided around the second oxygen-containing gas flow field 54, the inlet buffer 66a, and the outlet buffer 66b, a bead seal (hereinafter referred to as an “outer bead 69b”) provided outside the inner bead 69a, along the outer periphery of the first metal separator 16, and a plurality of bead seals (hereinafter referred to as a “passage bead 69c”) provided respectively around the plurality of fluid passages (oxygen-containing gas supply passage 20a, etc.).

A bridge section 70a is provided in the passage bead 69c around the oxygen-containing gas supply passage 20a. The bridge section 70a includes a plurality of tunnels 72a provided at intervals. Each of the tunnels 72a connects the oxygen-containing gas supply passage 20a and the oxygen-containing gas flow field 60 together.

A bridge section 70b is provided in the passage bead 69c around the oxygen-containing gas discharge passage 20b. The bridge section 70b includes a plurality of tunnels 72b provided at intervals. Each of the tunnels 72b connects the oxygen-containing gas discharge passage 20b and the oxygen-containing gas flow field 60 together.

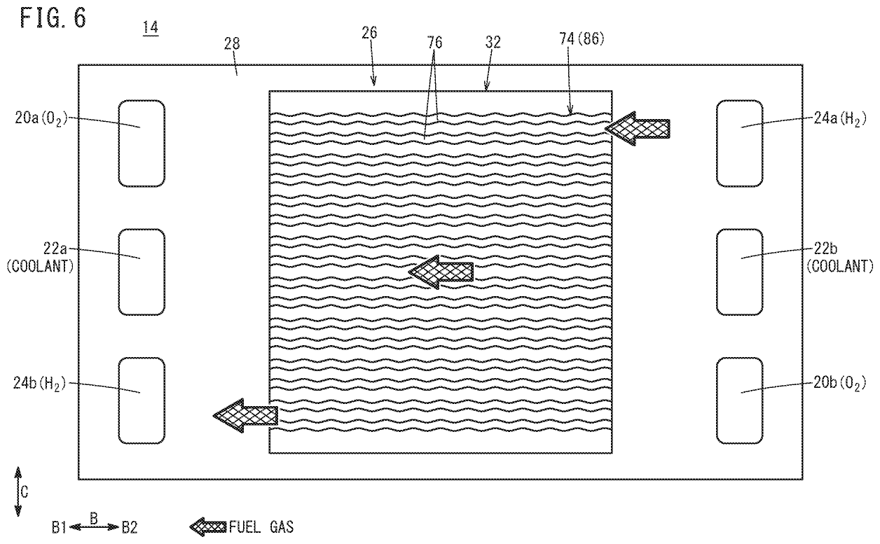

In FIGS. 2 and 6, the second porous body 32 is an electrically conductive rectangular flat plate member provided between the second metal separator 18 and the membrane electrode assembly 26. The second porous body 32 is joined to the other surface (second gas diffusion layer 46) of the membrane electrode assembly 26. The second porous body 32 is made of the same material as the second gas diffusion layer 46 (first porous body 30). That is, for example, the second porous body 32 is made of carbon paper or carbon cloth.

As shown in FIG. 6, the second porous body 32 has the substantially the same size as the membrane electrode assembly 26 in a plan view viewed in the stacking direction. However, the size and the shape of the second porous body 32 can be determined freely.

A first fuel gas flow field 74 for supplying the oxygen-containing gas to the second gas diffusion layer 46 is formed in the second porous body 32. The first fuel gas flow field 74 includes a plurality of first flow grooves 76 (first reactant gas flow field) which form a passage of the fuel gas as a reactant gas. The first flow grooves 76 extend in a wavy pattern along the anode 38 (FIG. 2) forming an electrode surface in the direction indicated by the arrow B. The first flow grooves 76 (first fuel gas flow field 74) extend in a wavy pattern over the entire length of the second porous body 32 in the direction indicated by the arrow B. The plurality of first flow grooves 76 are arranged at equal intervals in the direction indicated by the arrow C (width direction of the first flow grooves 76).

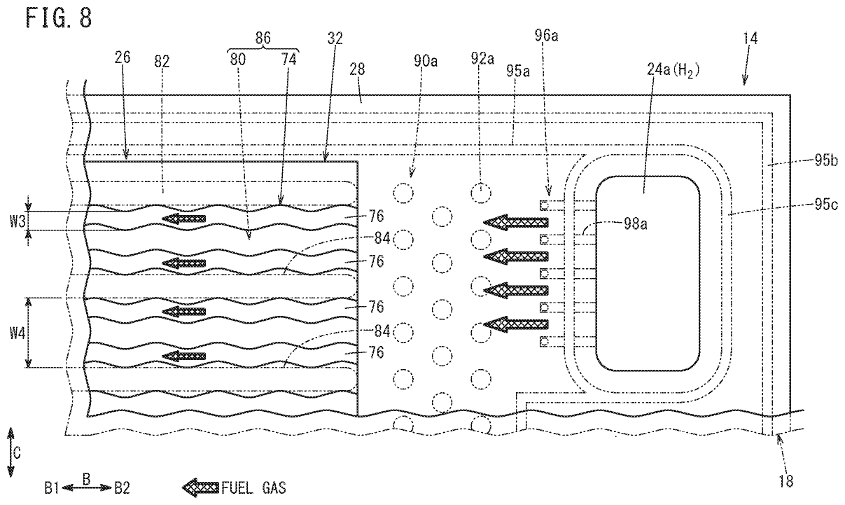

A width W3 (FIG. 8) and a depth D3 (FIG. 2) of the first flow grooves 76 are substantially constant over the entire length of the first flow grooves 76. It should be noted that the width W3 (FIG. 8) and the depth D3 (FIG. 2) of the first flow grooves 76 may change depending on the position in a direction in which the first flow grooves 76 extend.

In FIG. 2, the first flow grooves 76 extend through the second porous body 32, in a thickness direction (stacking direction) of the second porous body 32. The first flow grooves 76 have a rectangular shape in lateral cross section. It should be noted that the first flow grooves 76 may not have a rectangular shape in lateral cross section.

A water repellent part 78 is provided on a wall surface forming the first flow grooves 76. For example, the water repellent part 78 is formed by coating the wall surface that forms the first flow grooves 76, with alcohol solution containing fluorine resin. It should be noted that any method may be used to form the water repellent part 78 in or on the wall surface forming the first flow grooves 50. For example, the second porous body 32 may be formed to contain material having water repellency to form the water repellent part 78 in the wall surface forming the first flow grooves 76.

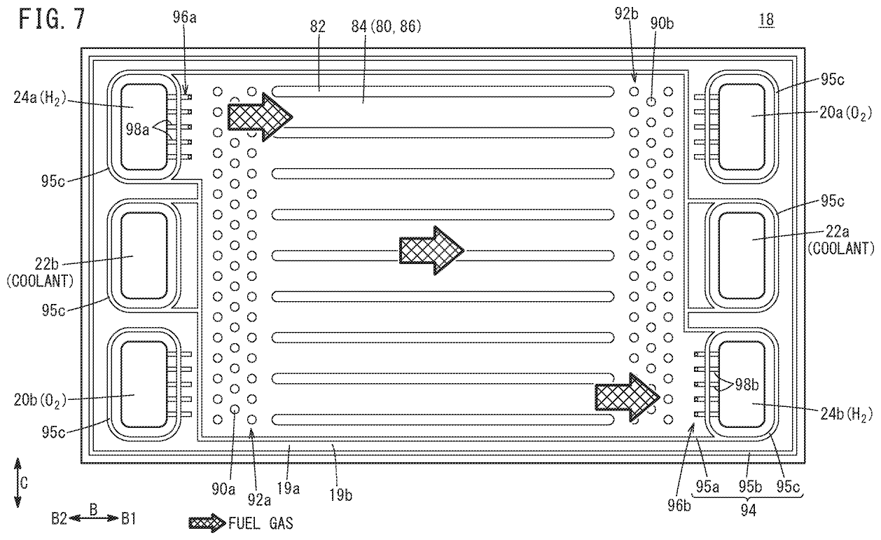

As shown in FIG. 7, the second metal separator 18 has a second fuel gas flow field 80 on its surface (hereinafter referred to as a “surface 19a”) facing the resin film equipped MEA 14. For example, the second fuel gas flow field 80 extends in the direction indicated by the arrow B. The second fuel gas flow field 80 includes a plurality of second flow grooves 84 (second reactant gas flow field) provided between a plurality of ridges 82 extending in a straight pattern in the direction indicated by the arrow B. Stated otherwise, the second fuel gas flow field 80 is formed by press forming of a metal flat plate. That is, the second flow grooves 58 extend in a straight pattern in the direction indicated by the arrow B.

As shown in FIG. 2, protruding end surfaces 85 of the ridges 82 contact the second porous body 32. A width W4 (FIG. 8) and a depth D4 of the second flow grooves 84 are substantially constant over the entire length of the second flow grooves 84. It should be noted that the width W4 (FIG. 8) and the depth D4 of the second flow grooves 84 may change depending on the position in a direction in which the second flow grooves 84 extend. The second flow grooves 84 are connected to the plurality of (in the embodiment of the present invention, e.g., two) first flow grooves 76.

Stated otherwise, in FIG. 8, the second flow grooves 84 are overlapped with a plurality of (two, in the embodiment of the present invention) first flow grooves 76, in a plan view in the stacking direction. The width W4 of the second flow grooves 84 is larger than the width W3 of the first flow grooves 76. Specifically, the width W4 of the second flow grooves 84 is two or more times larger than the width W3 of the first flow grooves 76. In FIG. 2, the depth D4 of the second flow grooves 84 is smaller than the depth D3 of the first flow grooves 76. Specifically, the depth D4 of the second flow grooves 84 is not more than ½ of the depth D3 of the first flow grooves 76. The widths W3, W4, the pitch, and the amplitude of the first flow grooves 76 and the second flow grooves 84 should be determined as necessary in a manner that the first flow grooves 76 and the second flow grooves 84 are overlapped with each other in a plan view.

The first fuel gas flow field 74 and the second fuel gas flow field 80 are connected together to form a fuel gas flow field 86 for supplying the fuel gas to the anode 38. The fuel gas flow field 86 is connected to (in fluid communication with) the fuel gas supply passage 24a and the fuel gas discharge passage 24b (see FIGS. 6 and 7).

An electrically conductive hydrophilic part 88 is provided on a wall surface forming the second flow grooves 84. For example, the hydrophilic part 88 is formed by depositing TiO₂ (titanium oxide) by thermal oxidation. However, any method may be used to form the hydrophilic part 88 in the wall surface facing the second flow grooves 84.

As shown in FIG. 7, in the surface 19a of the second metal separator 18, an inlet buffer 92a including a plurality of bosses 90a is formed between the fuel gas supply passage 24a and the second fuel gas flow field 80. In the surface 19a of the second metal separator 18, an outlet buffer 92b including a plurality of bosses 90b is provided between the fuel gas discharge passage 24b and the second fuel gas flow field 80.

A second seal line 94 is formed by press forming on the surface 19a of the second metal separator 18. The second seal line 94 protrudes toward the resin film equipped MEA 14 (FIG. 1). Resin material may be fixed to a ridge shaped front end surface of the second seal line 94 by printing or coating. For example, polyester fiber may be used as the resin material. The resin material may be provided on the part of the resin film 28.

The second seal line 94 includes a bead seal (hereinafter referred to as an “inner bead 95a”) provided around the second fuel gas flow field 80, the inlet buffer 92a, and the outlet buffer 92b, a bead seal (hereinafter referred to as an “outer bead 95b”) provided outside the inner bead 95a, along the outer periphery of the second metal separator 18, and a plurality of bead seals (hereinafter referred to as a “passage bead 95c”) provided respectively around the plurality of fluid passages (oxygen-containing gas supply passage 20a, etc.).

A bridge section 96a is provided in the passage bead 95c around the fuel gas supply passage 24a. The bridge section 96a includes a plurality of tunnels 98a provided at intervals. Each of the tunnels 98a connects the fuel gas supply passage 24a and the fuel gas flow field 86 together.

A bridge section 96b is provided in the passage bead 95c around the fuel gas discharge passage 24b. The bridge section 96b includes a plurality of tunnels 98b provided at intervals. Each of the tunnels 98b connects the fuel gas discharge passage 24b and the fuel gas flow field 86 together.

As shown in FIGS. 1 and 2, a coolant flow field 100 is formed between a surface 17b of the first metal separator 16 and a surface 19b of the second metal separator 18 that are joined together. The coolant flow field 100 is connected to (in fluid communication with) the coolant supply passage 22a and the coolant discharge passage 22b. When the first metal separator 16 and the second metal separator 18 are stacked together, the coolant flow field 100 is formed between a back surface of the second oxygen-containing gas flow field 54 of the first metal separator 16 and a back surface of the second fuel gas flow field 80 of the second metal separator 18. The first metal separator 16 and the second metal separator 18 are joined together by welding outer peripheral portions and portions around the fluid passages of the first metal separator 16 and the second metal separator 18. The first metal separator 16 and the second metal separator 18 may be joined together by brazing, instead of welding. An electrically conductive anti-corrosive membrane may be provided on at least one of the first metal separator 16 and the second metal separator 18. Such an anti-corrosive membrane may be made of gold or TiO₂ (oxide titanium)

The fuel cell 10A having the above structure is operated as follows:

Firstly, as shown in FIG. 1, an oxygen-containing gas such as the air is supplied to the oxygen-containing gas supply passage 20a. A fuel gas such as a hydrogen-containing gas is supplied to the fuel gas supply passage 24a. A coolant such as pure water, ethylene glycol, or oil is supplied to the coolant supply passage 22a.

As shown in FIGS. 3 and 4, the oxygen-containing gas flows from the oxygen-containing gas supply passage 20a into the oxygen-containing gas flow field 60 (the first oxygen-containing gas flow field 48 and the second oxygen-containing gas flow field 54). Further, as shown in FIG. 1, the oxygen-containing gas flows along the oxygen-containing gas flow field 60 in the direction indicated by the arrow B, and the oxygen-containing gas is supplied to the cathode 36 of the membrane electrode assembly 26. In this regard, the oxygen-containing gas chiefly flows in the first oxygen-containing gas flow field 48.

On the other hand, as shown in FIGS. 6 and 7, the fuel gas flows from the fuel gas supply passage 24a into the fuel gas flow field 86 (first and second fuel gas flow fields 74, 80). Then, the fuel gas flows along the fuel gas flow field 86 in the direction indicated by the arrow B, and the fuel gas is supplied to the anode 38 of the membrane electrode assembly 26. In this regard, the fuel gas chiefly flows in the first fuel gas flow field 74.

Thus, in each of the membrane electrode assemblies 26, the oxygen-containing gas supplied to the cathode 36 and the fuel gas supplied to the anode 38 are partially consumed in the electrochemical reactions of the first electrode catalyst layer 40 and the second electrode catalyst layer 44 to generate electricity. At this time, water is produced in power generation.

Then, as shown in FIGS. 3 and 4, after the oxygen-containing gas supplied to the cathode 36 is partially consumed at the cathode 36, the oxygen-containing gas flows from the oxygen-containing gas flow field 60 into the oxygen-containing gas discharge passage 20b, and the oxygen-containing gas is discharged along the oxygen-containing gas discharge passage 20b in the direction indicated by the arrow A. At this time, the water produced in the membrane electrode assembly 26 is guided from the first oxygen-containing gas flow field 48 into the second oxygen-containing gas flow field 54, and moves along the second oxygen-containing gas flow field 54 in the direction indicated by the arrow B. Then, the water is discharged together with the oxygen-containing gas along the oxygen-containing gas discharge passage 20b in the direction indicated by the arrow A.

Likewise, as shown in FIGS. 6 and 7, after the fuel gas supplied to the anode 38 is partially consumed at the anode 38, the fuel gas moves from the fuel gas flow field 86 into the fuel gas discharge passage 24b, and the fuel gas is discharged along the fuel gas discharge passage 24b in the direction indicated by the arrow A. At this time, the water produced in the membrane electrode assembly 26 permeates through the electrolyte membrane 34 from the cathode 36 to the anode 38, and the water is guided from the first fuel gas flow field 74 into the second fuel gas flow field 80. The water moves along the second fuel gas flow field 80 in the direction indicated by the arrow B, and then, the water is discharged together with the fuel gas along the fuel gas discharge passage 24b in the direction indicated by the arrow A.

Further, the coolant supplied to the coolant supply passage 22a flows into the coolant flow field 100 formed between the first metal separator 16 and the second metal separator 18, and flows in the direction indicated by the arrow B. After the coolant cools the membrane electrode assembly 26, the coolant is discharged from the coolant discharge passage 22b.

In this case, the fuel cell 10A according to the embodiment of the present invention offers the following advantages.

As described above, the first reactant gas flow field (first flow grooves 50, 76) are formed in the porous bodies (first and second porous bodies 30, 32), and the second reactant gas flow field (second flow grooves 58, 84) is formed in the metal separators (first and second metal separators 16, 18). In the structure, it is possible to comparatively reduce the depth of the second reactant gas flow field (second flow grooves 58, 84). Thus, since it is possible to simplify the shape of the molding die for forming the second reactant gas flow field (second flow grooves 58, 84), it is possible to achieve reduction of the production cost of the molding die, and extension of the product life of the molding die. Accordingly, it is possible to achieve reduction of the production cost of the fuel cell 10A.

Further, since the first reactant gas flow field (first flow grooves 50, 76) is formed in the porous bodies (first and second porous bodies 30, 32), in comparison with the case where the reactant gas flow fields are formed only in the metal separators (the first metal separator 16 and the second metal separator 18), it is possible to reduce the pressure losses of the reactant gases (the oxygen-containing gas and the fuel gas), and improve gas diffusion performance for the membrane electrode assembly 26. Accordingly, it is possible to improve power generation efficiency.

The first reactant gas flow field (first flow grooves 50, 76) extends in a wavy pattern, and the second reactant gas flow field (second flow grooves 58, 84) extends in a straight pattern. In the structure, since it is possible to simplify the molding die used for forming the second reactant gas flow field (second flow grooves 58, 84) to a greater extent, it is possible to achieve further reduction of the cost of the molding die, and further extension of the product life of the molding die. Accordingly, it is possible to achieve further reduction of the product cost of the fuel cell 10A.

The water repellent part 52 is provided for the wall surface forming the first reactant gas flow field (first flow grooves 50, 76).

In the structure, it is possible to suppress stagnation of the water produced during power generation in the first reactant gas flow field (first flow grooves 50, 76). Stated otherwise, it is possible to guide the produced water from the first reactant gas flow field (first flow grooves 50, 76) to the second reactant gas flow field (second flow grooves 58, 84) smoothly. In this manner, it is possible to allow the reactant gases (the oxygen-containing gas and the fuel gas) to flow in the first reactant gas flow field (first flow grooves 50, 76) smoothly.

The hydrophilic part 62 is provided for the wall surface forming the second reactant gas flow field (second flow grooves 58, 84).

In the structure, it is possible to allow the water to flow in the second reactant gas flow field (second flow grooves 58, 84) smoothly.

The depth of the second reactant gas flow field (the depth D2 of the second flow grooves 58 and the depth D4 of the second flow grooves 84) is smaller than the depth of the first reactant gas flow field (the depth D1 of the first flow grooves 50 and the depth D3 of the first flow grooves 76).

In the structure, since it is possible to simplify the shape of the molding die for forming the second reactant gas flow field (second flow grooves 58, 84) to a greater extent, it is possible to achieve further reduction of the production cost of the fuel cell 10A.

The width of the second reactant gas flow field (the width W2 of the second flow grooves 58 and the width W4 of the second flow grooves 84) is larger than the width of the first reactant gas flow field (the width W1 of the first flow groove 50 and the width W3 of the first flow grooves 76). In the structure, the produced water can flow in the second reactant gas flow field (second flow grooves 58, 84) smoothly.

In the present invention, the first porous body 30 or the second porous body 32 may be omitted. Also in this case, the above described advantages of the invention of the present application, i.e., reduction of the production cost and improvement of the power generation efficiency are achieved. In the case where the first porous body 30 is omitted, the depth D2 of the second flow grooves 58 of the first metal separator 16 may be larger than the depth D4 of the second flow grooves 84 of the second metal separator 18. In the case where the second porous body 32 is omitted, the depth D4 of the second flow grooves 84 of the second metal separator 18 may be larger than the depth D2 of the second flow grooves 58 of the first metal separator 16.

### Modified Embodiment

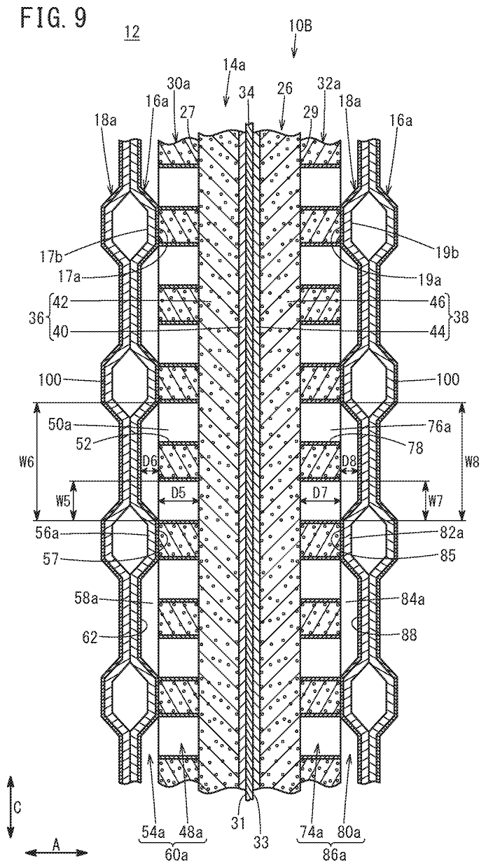

Next, a fuel cell 10B according to a modified embodiment will be described with reference to FIGS. 9 to 11. In this modified embodiment, the constituent elements that are identical to those of the above described embodiment are labeled with the same reference numeral, and description thereof is omitted.

As shown in FIGS. 9 to 11, the fuel cell 10B includes a resin film equipped MEA 14a, a first metal separator 16a, and a second metal separator 18a.

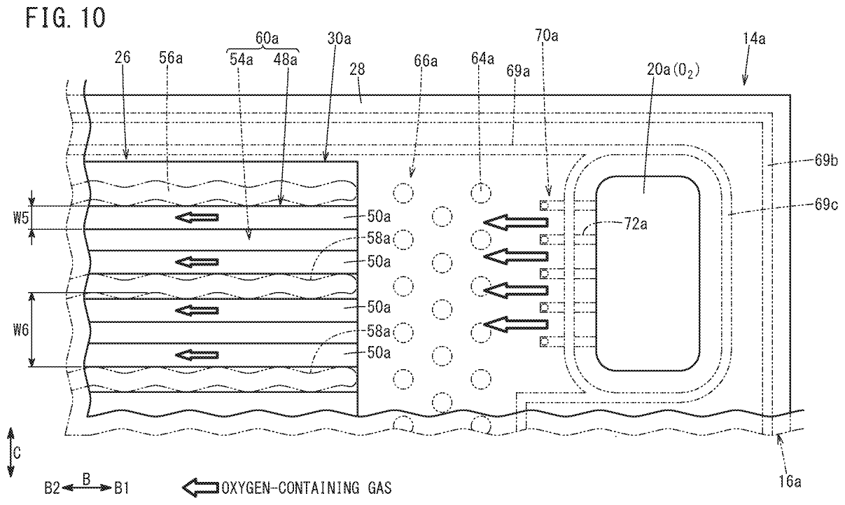

As shown in FIGS. 9 and 10, a first oxygen-containing gas flow field 48a for supplying an oxygen-containing gas to the first gas diffusion layer 42 is formed in a first porous body 30a of the resin film equipped MEA 14a. The first oxygen-containing gas flow field 48a includes a plurality of first flow grooves 50a (first reactant gas flow field) as a passage of the oxygen-containing gas (reactant gas) extending in a straight pattern along the cathode 36 (electrode surface) in the direction indicated by the arrow B. The first flow grooves 50a (first oxygen-containing gas flow field 48a) extend in a straight pattern over the entire length of the first porous body 30a in the direction indicated by the arrow B. The plurality of first flow grooves 50a are provided at equal intervals in the direction indicated by the arrow C (width direction of the first flow grooves 50a).

A width W5 (FIG. 10) and a depth D5 (FIG. 9) of the first flow grooves 50a are substantially constant over the entire length of the first flow grooves 50a. It should be noted that the width W5 (FIG. 10) and the depth D5 (FIG. 9) of the first flow grooves 50a may change depending on the position in a direction in which the first flow grooves 50a extend.

In FIG. 9, the first flow grooves 50a extend through the first porous body 30a, in a thickness direction (stacking direction) of the first porous body 30a. The first flow grooves 50a have a rectangular shape in lateral cross section. It should be noted that the first flow grooves 50a need not necessarily have a rectangular shape in lateral cross section. A water repellent part 52 is provided for a wall surface forming the first flow grooves 50a.

As shown in FIG. 10, a second oxygen-containing gas flow field 54a is formed on a surface 17a (FIG. 9) of the first metal separator 16a. The second oxygen-containing gas flow field 54a extends in the direction indicated by the arrow B. The second oxygen-containing gas flow field 54a includes a plurality of second flow grooves 58a (second reactant gas flow field) provided between a plurality of ridges 56a extending in a wavy pattern in the direction indicated by the arrow B. Stated otherwise, the second oxygen-containing gas flow field 54a is formed by press forming of a metal flat plate. That is, the second flow grooves 58a extend in a wavy pattern in the direction indicated by the arrow B.

As shown in FIG. 9, protruding end surfaces 57 of the ridges 56a contact the first porous body 30a. A width W6 (FIG. 10) and a depth D6 of the second flow grooves 58a are substantially constant over the entire length of the second flow grooves 58a. It should be noted that the width W6 (FIG. 10) and the depth D6 of the second flow grooves 58a may change depending on the position in a direction in which the second flow grooves 58a extend. The second flow grooves 58a are connected to the plurality of (in the embodiment of the present invention, e.g., two) first flow grooves 50a.

Stated otherwise, in FIG. 10, the second flow grooves 58a are overlapped with the plurality of (two, in the embodiment of the present invention) first flow grooves 50a, in a plan view in the stacking direction. The width W6 of the second flow grooves 58a is larger than the width W5 of the first flow grooves 50a. Specifically, the width W6 of the second flow grooves 58a is two or more times larger than the width W5 of the first flow grooves 50a. In FIG. 9, the depth D6 of the second flow grooves 58a is smaller than the depth D5 of the first flow grooves 50a. Specifically, the depth D6 of the second flow grooves 58a is not more than ½ of the depth D5 of the first flow grooves 50a. The widths W5, W6, the pitch, and the amplitude of the first flow grooves 50a and the second flow grooves 58a should be determined as necessary in a manner that the first flow grooves 50a and the second flow grooves 58a are overlapped with each other in a plan view.

The first oxygen-containing gas flow field 48a and the second oxygen-containing gas flow field 54a are connected together to form an oxygen-containing gas flow field 60a for supplying the oxygen-containing gas to the cathode 36. An electrically conductive hydrophilic part 62 is provided for a wall surface forming the second flow grooves 58a.

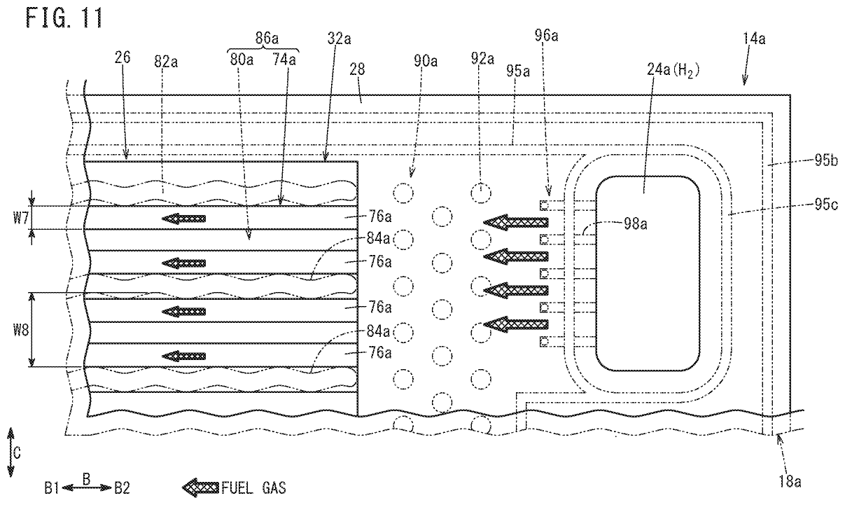

As shown in FIGS. 9 and 11, a first fuel gas flow field 74a for supplying a fuel gas to the second gas diffusion layer 46 is formed in a second porous body 32a of the resin film equipped MEA 14a. The first fuel gas flow field 74a includes a plurality of first flow grooves 76a (first reactant gas flow field) which form a passage of the fuel gas as a reactant gas. The first flow grooves 76a extend in a straight pattern along an anode 38 forming an electrode surface in the direction indicated by the arrow B. The first flow grooves 76a (first fuel gas flow field 74a) extend in a straight pattern over the entire length of the second porous body 32a in the direction indicated by the arrow B. The plurality of first flow grooves 76a are arranged at equal intervals in the direction indicated by the arrow C (width direction of the first flow grooves 76a).

A width W7 (FIG. 11) and a depth D7 (FIG. 9) of the first flow grooves 76a are substantially constant over the entire length of the first flow grooves 76a. It should be noted that the width W7 (FIG. 11) and the depth D7 (FIG. 9) of the first flow grooves 76a may change depending on the position in a direction in which the first flow grooves 76a extend.

In FIG. 9, the first flow grooves 76a extend through the second porous body 32a, in a thickness direction (stacking direction) of the second porous body 32a. The first flow grooves 76a have a rectangular shape in lateral cross section. It should be noted that the first flow grooves 76a may not have a rectangular shape in lateral cross section. A water repellent part 78 is provided for a wall surface forming the first flow grooves 76a.

As shown in FIG. 11, a second fuel gas flow field 80a is formed on a surface 19a (FIG. 9) of the second metal separator 18a. The second fuel gas flow field 80a extends in the direction indicated by the arrow B. The second fuel gas flow field 80a includes a plurality of second flow grooves 84a (second reactant gas flow field) provided between a plurality of ridges 82a extending in a wavy pattern in the direction indicated by the arrow B. Stated otherwise, the second fuel gas flow field 80a is formed by press forming of a metal flat plate. That is, the second flow grooves 84a extend in a wavy pattern in the direction indicated by the arrow B.

As shown in FIG. 9, protruding end surfaces 85 of the ridges 82a contact the second porous body 32a. A width W8 (FIG. 11) and a depth D8 of the second flow grooves 84a are substantially constant over the entire length of the second flow grooves 84a. It should be noted that the width W8 (FIG. 11) and the depth D8 of the second flow grooves 84a may change depending on the position in a direction in which the second flow grooves 84a extend. The second flow grooves 84a are connected to the plurality of (in the embodiment of the present invention, e.g., two) first flow grooves 76a.

Stated otherwise, in FIG. 11, the second flow grooves 84a are overlapped with the plurality of (two, in the embodiment of the present invention) first flow grooves 76a, in a plan view viewed in the stacking direction. The width W8 of the second flow grooves 84a is larger than the width W7 of the first flow grooves 76a. Specifically, the width W8 of the second flow grooves 84a is two or more times larger than the width W7 of the first flow grooves 76a. In FIG. 9, the depth D8 of the second flow grooves 84a is smaller than the depth D7 of the first flow grooves 76a. Specifically, the depth D8 of the second flow grooves 84a is not more than ½ of the depth D7 of the first flow grooves 76a. The widths W7, W8, the pitch, and the amplitude of the first flow grooves 76a and the second flow grooves 84a should be determined as necessary in a manner that the first flow grooves 76a and the second flow grooves 84a are overlapped with each other in a plan view.

The first fuel gas flow field 74a and the second fuel gas flow field 80a are connected together to form a fuel gas flow field 86a for supplying the fuel gas to the anode 38. A hydrophilic part 88 is provided for a wall surface forming the second flow grooves 84a.

The fuel cell 10B according to the modified embodiment offers the same advantages as in the case of the fuel cell 10A described above.

The fuel cell according to the present invention is not limited to the above described embodiment. It is a matter of course that various structures can be adopted without departing from the gist of the present invention.

What is claimed is:

1. A fuel cell comprising a membrane electrode assembly and metal separators provided on both sides of the membrane electrode assembly,
wherein a porous body is provided between each of the metal separators and the membrane electrode assembly;
a first reactant gas flow field as a passage of a reactant gas is formed in the porous body, the first reactant gas flow field extending in a wavy pattern along an electrode surface of the membrane electrode assembly;
a second reactant gas flow field as a passage of a reactant gas is formed in the metal separator, the second reactant gas flow field extending in a straight pattern along the electrode surface; and
the first reactant gas flow field extends through the porous body in a thickness direction of the porous body, and the first reactant gas flow field is connected to the second reactant gas flow field.

2. The fuel cell according to claim 1, wherein a water repellent part is provided for a wall surface forming the first reactant gas flow field.

3. The fuel cell according to claim 1, wherein a hydrophilic part is provided for a wall surface forming the second reactant gas flow field.

4. The fuel cell according to claim 1, wherein a depth of the second reactant gas flow field is smaller than a depth of the first reactant gas flow field.

5. The fuel cell according to claim 1, wherein a width of the second reactant gas flow field is larger than a width of the first reactant gas flow field.

6. The fuel cell according to claim 1, wherein the first reactant gas flow field comprises a plurality of the first reactant gas flow fields and the second reactant gas flow field comprises a plurality of the second fuel gas flow fields; and
the first reactant gas flow fields are connected to the second reactant gas flow fields.

7. The fuel cell according to claim 1, wherein the porous body has substantially same size as the membrane electrode assembly.

8. A fuel cell comprising a membrane electrode assembly and metal separators provided on both sides of the membrane electrode assembly,
wherein a porous body is provided between each of the metal separators and the membrane electrode assembly;
a first reactant gas flow field as a passage of a reactant gas is formed in the porous body, the first reactant gas flow field extending in a straight pattern along an electrode surface of the membrane electrode assembly;
a second reactant gas flow field as a passage of a reactant gas is formed in the metal separator, the second reactant gas flow field extending in a wavy pattern along the electrode surface; and
the first reactant gas flow field extends through the porous body in a thickness direction of the porous body, and the first reactant gas flow field is connected to the second reactant gas flow field.

9. The fuel cell according to claim 8, wherein a water repellent part is provided for a wall surface forming the first reactant gas flow field.

10. The fuel cell according to claim 8, wherein a hydrophilic part is provided for a wall surface forming the second reactant gas flow field.

11. The fuel cell according to claim 8, wherein a depth of the second reactant gas flow field is smaller than a depth of the first reactant gas flow field.

12. The fuel cell according to claim 8, wherein a width of the second reactant gas flow field is larger than a width of the first reactant gas flow field.

13. The fuel cell according to claim 8, wherein the first reactant gas flow field comprises a plurality of the first reactant gas flow fields and the second reactant gas flow field comprises a plurality of the second fuel gas flow fields; and
the first reactant gas flow fields are connected to the second reactant gas flow fields.

14. The fuel cell according to claim 8, wherein the porous body has substantially same size as the membrane electrode assembly.
